(19) United States
(12) Patent Application Publication
(10) Pub. No.: US 2004/0159196 A1
(43) Pub. Date: Aug. 19, 2004

(54) Ski boot spreader

(76) Inventors: John David Williams, Anchorage, AK (US); Frank J. Lang, Plainfield, IL (US)

Correspondence Address: BREINER & BREINER, 115 NORTH HENRY STREET, P. O. BOX 19290, ALEXANDRIA, VA, 22314, US

(21) Appl. No.: 10/365,451

(22) Filed: Feb. 13, 2003

(51) Int. Cl. B25B 11/00

(52) U.S. Cl. 81/485

(57) ABSTRACT

A tool for spreading apart a leg portion of a ski boot including a handle portion and a plate portion wherein the plate portion has at an end thereof means for engaging an inner piece of the leg portion and the handle portion at the end thereof has means for engaging an outer piece partially overlapping the inner piece of a ski boot leg portion. The means for engaging includes a first recess which opens inward of the plate portion and a second recess which opens outward of the handle portion. The handle portion and the plate portion are preferably separate components joined together in rotational relation to each other, preferably by a pivot fastening means.

### FIELD OF THE INVENTION

The present invention relates to a tool for spreading apart a leg portion of a ski boot. More particularly, the invention relates to a tool for spreading apart a ski boot leg portion divided into an inner piece and an outer piece which partially overlaps the inner piece. The tool spreads apart by cam action the inner piece and the outer piece at the overlapping portion to provide an opening for introducing a skier's foot into the ski boot. The tool includes a handle rotatably connected to a plate wherein the handle and plate are adapted to engage an edge of the inner piece and the outer piece of the ski boot leg portion.

### BACKGROUND OF THE INVENTION

A significant problem to the enjoyment of skiing is the difficulty a skier encounters while putting on a ski boot. This difficulty has been exacerbated by current boot designs which call for an increasingly stiffened boot in order to provide the skier greater control of the ski. The increased stiffness of the boot makes it difficult for the skier to negotiate the right angle bend at the ankle joint of the ski boot which is required to insert the skier's foot in the boot. Thus, often two people, i.e. four hands, are required to slide the skier's foot into the ski boot. One set of hands is used to pry open the boot while pulling forward the tongue of the boot and the other set of hands is used to pull up on the ankle portion of the boot. Aside from requiring two people to put on a ski boot in this manner, the maneuver is extremely frustrating. Moreover, quite often, the maneuver is accompanied by cuts to the hands received from the sharp edges of the molded plastic of the boot.

### OBJECTS AND BRIEF DESCRIPTION OF THE INVENTION

An object of the invention is to provide a tool for spreading apart the leg portion of a ski boot to provide an opening through which a skier can insert his foot into the ski boot.

A further object of the invention is to provide a tool for spreading apart a ski boot leg portion that enables a skier to put on a ski boot without the help of another.

A further object of the present invention is to provide a tool for spreading apart a ski boot leg portion that locks into place between an inner piece of a ski boot leg portion and a partially overlying outer piece of the boot leg portion upon engagement of the tool with the inner and outer pieces and subsequent partial rotation of the tool.

Another object of the invention is to provide a tool for spreading apart a ski boot leg portion where the ski boot leg portion has a front portion divided into an inner piece and a partially overlying outer piece, wherein the tool includes a handle and a plate wherein a first recess in the plate engages an edge of the inner piece and a second recess in the handle engages an edge of the outer piece.

A further object of the invention is to provide a tool for spreading apart a ski boot leg portion divided into an inner piece and an outer piece partially overlapping the inner piece, the tool including a handle and a plate including a first recess and a second recess wherein the first recess and the second recess are constructed and arranged such that upon engagement with the respective inner and outer pieces and subsequent partial rotation of the tool, opposing forces exerted by the inner and outer pieces lock the tool in place between the inner and outer pieces such that the inner and outer pieces are held spread apart from each other.

The invention is directed to a tool generally including a handle portion and a plate portion wherein the plate portion includes a means for engaging an inner piece and the handle portion includes a means for engaging an outer piece that partially overlaps the inner piece of a ski boot leg portion. The means for engaging includes a pair of recesses that are constructed and arranged such that upon engagement with the respective boot leg portion pieces and subsequent cam action or partial rotation of the tool, preferably the handle in rotation to the plate, opposing forces exerted by the inner and outer pieces lock the tool in place between the pieces while spreading the pieces apart. A first recess in the plate portion can be substantially C-shaped and is present in at least a front end of the plate portion and faces inward of the plate portion with respect to the tool. The first recess is provided as space between the bottom surface of the plate portion and a lip extending inward from a downward extending portion of the plate portion. The first recess is adapted to receive the leading edge of the inner piece. A second recess is present in the handle portion, preferably in the form of a groove which extends around a front portion of the handle portion. The second recess is adapted to receive a leading edge of the outer piece. The handle portion and plate portion are preferably two separate components retained together by a pivotal fastening means, such as a pivot screw, which in addition to retaining the handle portion and plate portion together allows the handle portion to rotate in relation to the plate portion when the inner piece is positioned in the first recess of the plate portion.

In use, the end of the plate portion including the first recess is slid between the inner piece and outer piece of the ski boot leg portion such that the first recess receives the leading edge of the inner piece. The leading edge of the outer piece is received in the second recess in the front of the handle portion. The handle portion is then rotated 180° (right or left depending on whether the left boot or right boot is being put on) in relation to the plate; portion which is held stationary due to its engagement with the boot. The leading edge of the outer piece slides within the second recess as the handle portion is rotated. Upon rotation to the rear side of the front portion of the handle portion, the outer piece is spread apart from the inner piece thereby enlarging the opening through which a foot is inserted into the boot. The spreading apart is due to the front portion of the handle portion being of a shorter length in the front between the screw means and the second recess and longer in the back between the screw means and the second recess. The force exerted by the opposing leading edges of the boot leg pieces lock the tool therebetween. This enables hands-free spreading apart of the ski boot leg portion. The user can then easily pull the boot tongue forward and insert a foot into the boot.

### BRIEF DESCRIPTION OF DRAWINGS

FIG. 1 is a perspective view of a conventional ski boot with which the tool of the invention can be used.

FIG. 2 is a partial top view of the ski boot leg portion illustrated in FIG. 1 in a closed and latched position.

FIG. 3 is a top view of the ski boot leg portion of FIG. 2 in an open and unlatched position.

FIG. 4 is a side and partial cross-sectional view of a tool for spreading apart a ski boot leg portion in accordance with the invention as the tool is inserted between an outer piece which partially overlaps an inner piece of the ski boot leg portion of FIG. 1.

FIG. 5 is a side and partial cross-sectional view of the tool of FIG. 4 after rotation of the handle portion 180° showing the outer piece of the boot leg portion spread apart from the inner piece of the boot leg portion.

FIG. 6 is a top view of the plate portion of the tool.

FIG. 7 is a side and partial cross-sectional view of the plate portion of FIG. 6.

FIG. 8 is a side and partial cross-sectional view of the handle portion of the tool.

FIG. 9 is a top view of the handle portion of FIG. 8.

FIG. 10 is a bottom view of the handle portion of FIG. 8.

FIG. 11 is a front view of the handle portion of FIG. 8.

### DETAILED DESCRIPTION OF PRESENTLY PREFERRED EMBODIMENTS

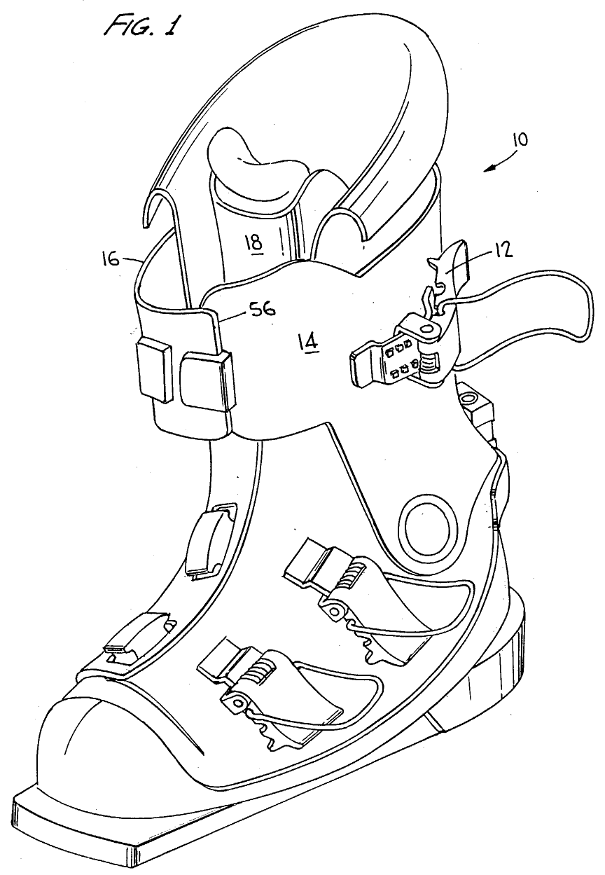

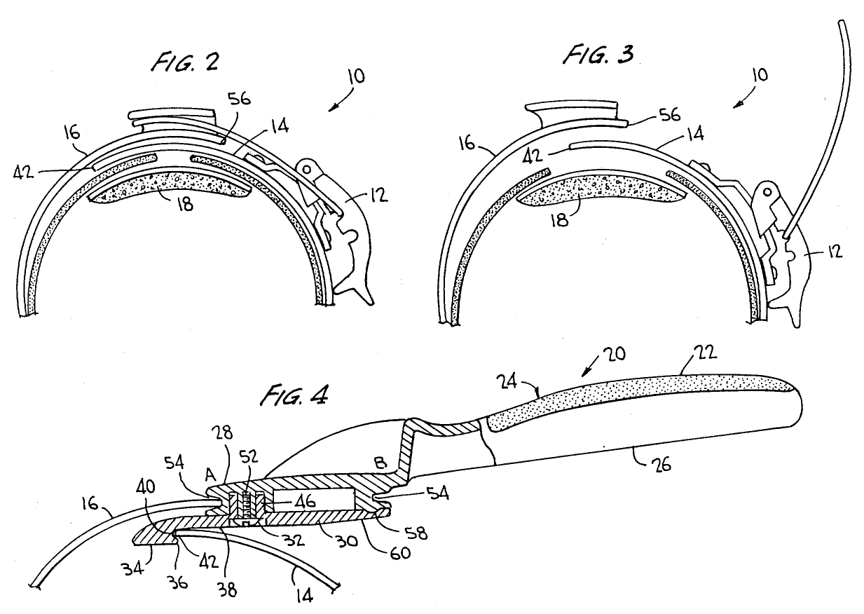

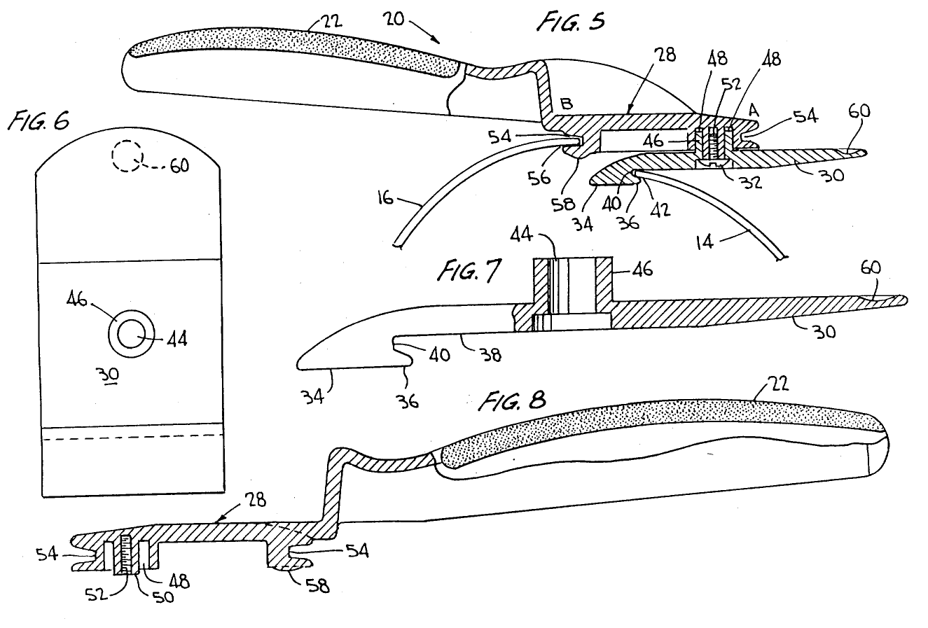

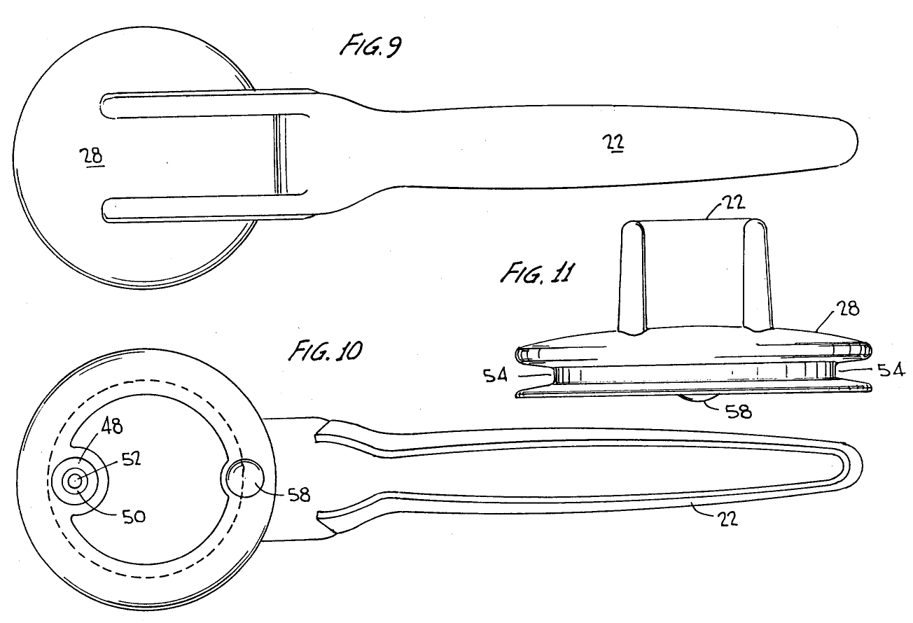

A preferred embodiment of a tool for spreading apart a ski boot leg portion is shown in FIGS. 4 through 11. Prior to describing in detail the embodiments of the present invention, a conventional ski boot with which the tool of the invention is useful will be described in relation to FIGS. 1-3. FIGS. 1-3 show a ski boot having a ski boot leg portion 10. Ski boot leg portion 10 includes means 12 for closing and locking boot leg portion 10 which, in FIG. 2 is shown in the closed position and in FIG. 3 in an open position. Means 12 is generally of a conventional locking latch or lever type and therefore is not described herein in detail.

Boot leg portion 10 includes an inner piece 14 and an outer piece 16 which partially overlaps inner piece 14. According to one characteristic of a ski boot including a boot leg portion of the type shown in FIGS. 1-3, inner piece 14 and outer piece 16 can be spread apart from each other so that they are no longer overlapping and a tongue 18 inside of the boot leg portion can be pulled forward to provide a larger opening in boot leg portion 10 which allows a skier's foot to be inserted through the opening into the boot leg portion and ultimately fully into the ski boot. The invention provides a tool 20 for separating inner piece 14 and outer piece 16 and creating an opening therebetween providing additional space for insertion of a skier's foot into the ski boot.

Tool 20 in accordance with the preferred embodiment of the invention is as shown in FIGS. 4 through 11 and includes a substantially rigid handle portion 22 made of any suitably rigid material such as plastic, wood, metal or a composite material. Handle portion 22 has a top side 24 facing a first direction, a bottom side 26 opposite thereto facing a second direction, and a front portion 28. It is contemplated that tool 20 can be any shape and cross-section that does not interfere with the purpose and operation of the tool 20. The preferred embodiments, however, have at least a front portion with a width sufficient to stably maintain the tool in position between the inner piece 14 and outer piece 16, i.e. to avoid slippage or a falling sidewise of the tool when in use. The handle portion may or may not be of the same width as the front portion of the tool.

Tool 20 additionally includes a plate portion 30. Plate portion 30 can be made as one piece with handle portion 22 with minor modification as noted below. However, handle portion 22 and plate portion 30 are preferably two separate components held together by a pivoting fastening means, such as a pivot screw 32. Two components are preferred in part due to the lesser cost in making the mold used to manufacture the tool and the greater ease in release from the mold.

Plate portion 30 is substantially planar with a downward projecting front edge 34 having an inward projecting lip 36. Lip 36 in conjunction with bottom surface 38 of plate portion 30 provides a first recess 40 for receiving a leading edge 42 of inner piece 14. In the preferred embodiment as shown in FIGS. 4-5 and 7, lip 36 extends only from front edge 34. If tool 20 is one piece, lip 36 will extend inward of the entire periphery of plate portion 30.

Plate portion 30 in the preferred embodiment has an opening 44 therethrough with a collar 46 extending upward from the top surface of plate portion 30. Collar 46 is received in complementarily-shaped recess 48, as shown in FIGS. 4, 5, 8 and 10. A wall 50 is present therein to provide an inner recess 52. A pivoting fastening means, such as shown for example by pivot screw 32, extends through opening 44 in plate portion 30 into inner recess 52 of handle portion 20 where it is threadingly received in a conventional manner in the case of a pivot screw. Plate portion 30 is thereby held to the front portion 28 of handle portion 20.

Present in front portion 28 of the handle portion 20 is means for engaging outer piece 16 of boot leg portion 10. The means for engaging includes a recess 54 which extends around the periphery of front portion 28 as shown in FIGS. 4, 5, 8 and 11. This arrangement allows recess 54 to engage leading edge 56 of outer piece 16 when tool 20 is initially inserted between pieces 14 and 16 and is retained therein during use of tool 20. Front edge 34 of plate portion 30 is preferably curved to ease the insertion of the front end of tool 20 between inner piece 14 and outer piece 16 in use.

In use, tool 20 is inserted front end 34 first between inner piece 14 and outer piece 16. Tool 20 is oriented such that bottom side 26 of handle 22 is adjacent inner piece 14 as shown in FIG. 4. Tool 20 as illustrated in FIGS. 4-5 is inserted a sufficient distance between pieces 14 and 16 such that edge 42 enters recess 40 as shown in FIG. 4. Leading edge 56 of outer piece 16 is simultaneously received in recess 54 of front portion 28 of handle portion 22. Upon pivoting or partial rotation to 180° of tool 20, edge 42 of inner piece 14 remains positioned in recess 40 and edge 56 of outer piece 16 moves within recess 54 from the front side A of front portion 28 to the back side B. FIG. 4 shows the position of tool 20 in relation to pieces 14 and 16 upon initial insertion and FIG. 5 shown the position of tool 20 following camming 180°. Tool 20 becomes locked between opposing edges 42 and 56, as shown in FIG. 5. The force exerted by inner piece 14 and outer piece 16 when spread apart, with edges 42 and 56 engaged within recesses 40 and 54, respectively, hold tool 20 in place while spreading apart ski boot leg portion 10. Upon rotation of handle portion 22 and movement of edge 56 in recess 54 from front side A to back side B, outer piece 16 is spaced away from inner piece 14. As seen from viewing FIGS. 4-5, the repositioning of front portion 28 results in edge 56 and recess 54 being initially positioned atop plate portion 30 and inner piece 14 (FIG. 4) to being positioned in front of and away from front edge 34 of plate portion 30 (FIG. 5). In this way, an opening of sufficient size is created in boot leg portion 10 to allow a skier to insert his or her foot into the ski boot. This is done “hands-free” once tool 20 has been rotated 180°. To remove tool 20, the handle portion is return rotated to its original position and tool 20 slid out from between inner piece 14 and outer piece 16. Thereafter, using closure member 12, the boot is closed and locked and ready for skiing.

Pivot fastening means 32 is constructed and arranged so that handle portion 22 may pivot left or right 180°. This allows the tool 20 to be used in any direction simplifying use with a right foot boot or left foot boot and use by a left- or right-handed person.

When the tool 20 is of a one piece design, the provision of lip 36 around the periphery of plate portion 30 allows edge 42 to move within recess 40 as the handle is rotated around to spread apart outer piece 16 from inner piece 14. Necessarily, the positioning of lip 36 will be such as to create the difference in spacing upon rotation as described above.

In the preferred embodiment, to maintain handle portion 22 in position in relation to plate portion 30 during non-use and upon initial use during insertion between pieces 14 and 16, handle portion 22 includes a rounded protrusion 58 which sits within a depression 60 on plate portion 30. The protrusion easily overrides the depression upon slight pressure.

As will be apparent to one skilled in the art, various modifications can be made within the scope of the aforesaid description. Such modifications being within the ability of one skilled in the art form a part of the present invention and are embraced by the appended claims. For example, the handle can have one or a combination of various cross-sections such as square, rectangular, circular, etc. Further, it is apparent to one skilled in the art that the handle can be of any shape and does not have to be straight. Therefore it can be bent so long as the bend therein does not hinder rotation of the tool. In addition, the distance separating the recesses can be increased or decreased in order to increase or decrease, respectively, the opening created between the edges of the pieces of the ski boot leg portion when the tool is locked therebetween.

It is claimed:

1. A tool for spreading apart a ski boot leg portion having an inner piece and an outer piece partially overlapping the inner piece, the inner piece and the outer piece defining an opening for introducing a skier's foot into a ski boot, the tool comprising a handle portion, a plate portion connected to said handle portion, said plate portion including a first recess constructed and arranged to engage an edge of said inner piece, and said handle portion including a second recess constructed and arranged to engage an edge of said outer piece.

2. The tool according to claim 1 wherein said first recess opens inward of the plate portion.

3. The tool according to claim 1 or 2 wherein said second recess opens outward from the periphery of a front portion of said handle portion.

4. The tool according to claim 1 or 2 wherein said handle portion is rotationally connected to said plate portion.

5. The tool according to claim 3 wherein said handle portion is rotationally connected to said plate portion.

6. The tool according to claim 4 wherein a pivot fastening means serves to rotationally connect said handle portion to said plate portion.

7. The tool according to claim 5 wherein a pivot fastening means serves to rotationally connect said handle portion to said plate portion.

8. The tool according to claim 1 or 2 wherein said first recess and said second recess are constructed and arranged such that upon engagement with said inner piece and said outer piece and subsequent to at least partial rotation of the handle portion, opposing forces exerted by said inner piece and said outer piece hold the tool in place between said inner piece and said outer piece.

9. The tool according to claim 3 wherein said first recess and said second recess are constructed and arranged such that upon engagement with said inner piece and said outer piece and subsequent to at least partial rotation of the handle portion, opposing forces exerted by said inner piece and said outer piece hold the tool in place between said inner piece and said outer piece.

10. The tool according to claim 3 wherein said front portion is unitarily joined to said handle portion such that said second recess forms one end of the handle.

11. The tool according to claim 3 wherein said front portion includes said second recess and is unitarily joined to the handle portion, and said handle portion is movably connected to said plate portion.

12. A tool for spreading apart a ski boot leg portion having an inner piece and an outer piece partially overlapping the inner piece, the inner piece and the outer piece defining an opening for introducing a skier's foot into a ski boot, the tool comprising:
a handle portion having a front portion with a recess' extending along its periphery constructed and arranged to engage an edge of said outer piece, and
a plate portion rotatably connected to said handle portion, said plate portion including a first recess in a front end of said plate portion constructed and arranged to engage an edge of said inner piece.

13. The tool according to claim 12 wherein said first recess opens inward of said plate portion.

14. The tool according to claim 12 or 13 wherein said first recess and said second recess are constructed and arranged such that upon engagement with said inner piece and said outer piece and at least partial rotation of the handle portion, opposing forces exerted by said inner piece and said outer piece hold the tool in place therebetween.

15. The tool according to claim 12 wherein said plate portion is rotatably connected to said handle portion by a pivot fastening means.

16. A method of spreading apart a ski boot leg portion including an inner piece and an outer piece partially overlapping the inner piece, comprising:
providing a tool having means for engaging an edge of the inner piece and an edge of the outer piece,
inserting said tool between the inner piece and the outer piece a distance sufficient to engage the edge of the inner piece and the edge of the outer piece, and
at least partially rotating said tool to further separate the inner piece and the outer piece.

17. The method of claim 16 further comprising holding said tool between the edge of the inner piece and the edge of the outer piece following said at least partial rotation of said tool.

18. The method of claim 16 wherein said means for engaging includes a first recess and a second recess.
